(19) United States
(12) Patent Application Publication
(10) Pub. No.: US 2017/0072820 A1
(43) Pub. Date: Mar. 16, 2017

(54) CAR SEAT HEAD SUPPORT

(71) Applicant: Robert Moore, Mount Vernon, NY (US)

(72) Inventor: Robert Moore, Mount Vernon, NY (US)

(21) Appl. No.: 14/851,324

(22) Filed: Sep. 11, 2015

(51) Int. Cl. B60N 2/48; B60R 22/10

(52) U.S. Cl. CPC B60N 2/4879; B60N 2/4805; B60R 22/105; B60N 2002/4888

(57) ABSTRACT

A head support system for a child seat that includes: a flat dome-shaped surface; support padding surrounding the flat surface; a series of slats along the flat surface; a head support bar at a top of the dome surface; and levers extending from the head support bar, where the levers are capable of extending around the chin of a child within the car seat. The head support system also includes a series of openings along each lever to provide a means to adjust the length and support of the levers across a child's chin. Three slots are provided along the back surface along the flat surface, where the support system is interchangeable between car seats to provide head support for a child user.

### BACKGROUND OF THE INVENTION

Field of Invention

The present invention relates to a car seat head support system that is implemented onto a conventional child car seat.

Description of Related Art

Car seats are required for the transport of small children in automobiles and other motor vehicles. Typically, the car seat is secured through a seatbelt and the child is placed within the car seat with supports and belts within the seat itself The seats are effective in protecting the child from being tossed around an automobile in case of any type of accident or collision. One shortcoming of the typical child car seat is the ineffective ability to support the head of the child in the car seat. Many times the child's head may hang or bend to one side or forward if the child happens to doze off or go to sleep. As a result the child may have to endure constant bobbing and/or jerking of the child's head and neck while in a car seat. This situation could cause injury to the child's neck and possibly the child's spine. As a result, it would be advantageous to have a device that could be inserted into a conventional car seat to provide head support for the infant secured in the car seat.

### SUMMARY OF THE INVENTION

The present invention relates to a head support system for a child seat that includes: a flat dome-shaped surface; support padding surrounding the flat surface; a series of slats along the flat surface; a head support bar at a top of the dome surface; and levers extending from the head support bar, where the levers are capable of extending around the chin of a child within the car seat. The head support system also includes a series of openings along each lever to provide a means to adjust the length and support of the levers across a child's chin. Three slots are provided along the back surface along the flat surface, where the support system is interchangeable between car seats to provide head support for a child user.

### BRIEF DESCRIPTION OF DRAWINGS

FIG. 1 depicts a front view of a car seat head support in accordance with the present invention.

### DETAILED DESCRIPTION

The present invention relates to a car seat head support that is inserted and attached to a car seat that includes adjustable flexible levers that are wrapped around the child's chin to support and stabilize a child's head while riding in a car seat. These adjustable levers are strapped around the child's chin and have sufficient padding and flexibility to comfortably but firmly support the child's head while in the car seat. Use of the car seat head support according to present invention avoids any head movement associated with a child in a car seat.

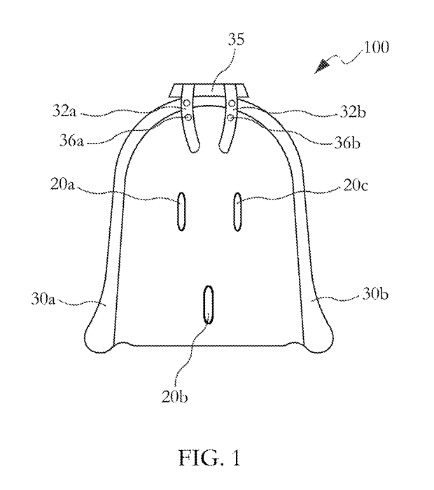

In reference to FIG. 1, a car seat head support 100 is depicted. The car seat head support 100 includes a rear surface 25 that is surrounded by a support padding 30a, 30b, on each respective side of the Head Support 100. The rear surface 25 further includes seatbelt slots 20a, 20b, and 20c. The slots 20a, 20b, and 20c can be aligned with the slots available on a car seat to secure the head support 100 into place. At the top of the head support 100 is a bar 35. The bar 35 provides rear support of the head of the child that is inserted into the car seat. Each side of the bar is a support lever 32a, 32b. The support levers 32a, 32b extend around each side of the child's chin when placed in the car seat. Adjustment openings 36a, 36b adjust the positioning of the levers 32a, 32b as needed around the front chin of the child and the car seat. Once in place these levers help keep the child's head in an upright position and avoid the forward bobbing and side to side movement that may occur in a normal car seat.

Once installed these support levers 32a, 32b provide a soft mesh material but firm enough to provide the stability needed to support the child's head in a stable position. Conveniently, the head support 100 may be removed and inserted into various car seats as needed for providing additional head support for an infant in the car seat. The instant invention has been shown and described in what it considers to be the most practical and preferred embodiments. It is recognized, however, that departures may be made there from within the scope of the invention and that obvious modifications will occur to a person skilled in the art.

1. A head support system for a child seat comprising:
a. a flat dome-shaped surface;
b. support padding surrounding the flat surface;
c. a series of slats along the flat surface;
d. a head support bar at a top of the dome surface; and
e. levers extending from the head support bar, where the levers are adapted to extend around the chin of a child within the car seat.

2. The head support system according to claim 1 further comprising a series of openings along each lever to provide a means to adjust the length and support of the levers across a child's chin.

3. The head support system according to claim 1, where three slots are provided along the back surface along the flat surface.

4. The head support system according to claim 1, where the support system is interchangeable between car seats to provide head support for a child user.
